(19) United States
(12) Patent Application Publication
(10) Pub. No.: US 2025/0108530 A1
(43) Pub. Date: Apr. 3, 2025

(54) DEVICES AND METHODS FOR SMART PERSONAL GROOMING

(71) Applicant: The Gillette Company LLC, Boston, MA (US)

(72) Inventors: Aditya Milind Deshpande, Cincinnati, OH (US); Eduardo Romo Escalante, Reading (GB); Faiz Feisal Sherman, Mason, OH (US); Ian Anthony Good, Reading (GB)

(21) Appl. No.: 18/479,369

(22) Filed: Oct. 2, 2023

(51) Int. Cl. B26B 19/38; B26B 19/02; B26B 19/14; B26B 19/20; G06V 10/14; G06V 10/26; G06V 10/44; G06V 10/764; G06V 10/774; G06V 10/82; G06V 20/50; G06V 40/10

(52) U.S. Cl. CPC B26B 19/388; B26B 19/20; G06V 10/14; G06V 10/26; G06V 10/44; G06V 10/764; G06V 10/774; G06V 10/82; G06V 20/50; G06V 40/10; B26B 19/02; B26B 19/14; B26B 19/384

(57) ABSTRACT

A smart personal grooming device or otherwise cutting device comprises a body with a handle, a head portion, a hair cutting implement, and a camera oriented toward the hair cutting implement. The camera captures images of a skin area and a hair area of a user and a processor detects, based the images, each of the skin area and the hair area. A boundary is defined between the skin area and the hair area. The processor determines a control state based on the boundary that causes the processor to implement one or more algorithms controlling an operating or feature of the smart personal grooming device or otherwise cutting device, including, for example, activating the cutting implement to cause the cutting implement to remove hair in a hair area of the user.

### FIELD

The present disclosure generally relates to grooming devices and methods, and more particularly to, devices and methods for smart personal grooming.

### BACKGROUND

Users typically experience difficulty guiding or handling shaving devices in precise manners to trim or otherwise cut their own hair. This problem can be particularly acute for areas difficult to reach or see, such as the user's face or otherwise an area that requires the user to shave by use of a mirror or other indirect vision. For these reasons, precise shaving or hair removal requires manual assistance of another person. For example, an individual with facial hair can visit a barber for assistance with cutting or trimming hair. After a few days, however, the facial hair begins to regrow (e.g., have hair stubble), and the user cannot readily maintain a style or cut himself or herself as previously provided by a barber.

Conventional trimming devices do not assist users, who have facial hair (or other difficult to address hair areas), to trim or cut such hair. An individual typically requires ad hoc tools like beard stencils over the face while shaving to maintain facial hair styles by themselves, which typically results in imprecise styles or cuts, or can also result in damage to user's skin from lacerations caused by a blade or trimmer, pulled hair, or other skin damage provided by manual attempts at precise cutting or trimming.

In addition, previously known methods for hair style maintenance rely on shaping tools or chemical markers (e.g., dyes) for defining the hair style edges in addition to manual cutting using a manual instrument for cutting the hair and/or stubble. However, the use of these manual tools and/or chemicals makes the process of self-style maintenance difficult.

For the foregoing reasons, there is a need for devices and methods for smart personal grooming.

### SUMMARY

In various aspects herein, smart personal grooming devices and methods are described to address imprecise trimming or cutting, and/or to otherwise enhance user shaving. Such precision is achieved through image acquisition and image analysis captured while the user is shaving with a smart personal grooming or cutting device. Such a smart shaving device, also referred to herein as an “AutoEdger device,” can determine how or when to cut or trim hair based on image acquisition and analysis. The AutoEdger device provides a digital and image-based solution to enhance hair cutting and trimming, with the increased safety of using such a device having a sharp blade. The AutoEdger device also provides a standalone solution that can perform precise trimming and/or cutting itself by using a sensor to control a trimmer or blade.

Generally, the AutoEdger device comprises a hair trimmer or cutter with a sensor, e.g., an inbuilt optical sensor or otherwise a camera. The AutoEdger device comprises a sense-and-respond type of device for seamlessly and quickly maintaining precise hairstyles. Users with a hairstyle (e.g., a facial hairstyle) typically visit barbers for their styling. Their hair starts to regrow after the styling, and the crisp edges between the skin and the hair start to disappear after two or three days from the styling. Assuming that the average hair growth rate is approximately 0.3 mm per day, the AutoEdger device allows a user, himself or herself, to maintain precise or crisp edges between the skin and hair for an extended amount of time. The AutoEdger can detect and cut hair stubble, and can be configured to cut at a certain threshold height, such that the AutoEdger device may cut only the regrown hair (stubble). Therefore, users with a certain hairstyle (e.g., a certain beard style) can use the AutoEdger device to maintain their styles for an extended amount of time.

In some aspects, the techniques described herein relate to a smart personal grooming device including: a body including a handle; a head portion connected to the body and a hair cutting implement; a camera oriented toward the hair cutting implement and configured to capture images of a skin area and a hair area of a user when operating the smart personal grooming device; a processor communicatively coupled to the camera; a memory communicatively coupled to the processor and storing computing instructions that, when executed by the processor, causes the processor to: capture, by the camera, one or more images depicting the skin area of the user and the hair area of the user, detect, based on one or more images, each of the skin area and the hair area, wherein a boundary is defined between the skin area and the hair area; and determine a control state based on the boundary as detected in the one or more images, wherein the control state causes the computing instructions to execute the processor to implement at least one of: (a) activate the hair cutting implement to cause the hair cutting implement to remove hair in the hair area of the user; (b) deactivate the hair cutting implement; (c) activate of a haptic vibrator of the smart personal grooming device; (d) activate an audio device of the smart personal grooming device; (e) initiate a visual indicator of the smart personal grooming device; or (f) changing a cutting speed of the hair cutting implement.

In additional aspects, the techniques described herein relate to a smart personal grooming device further including: a learning model stored in the memory and trained with a plurality of images of users when operating the smart personal grooming device, wherein the learning model is configured to output at least one classification based on whether hair identified in an image of the plurality of images is depicted as above a hair length threshold or below the hair length threshold, and wherein the control state is based on the at least one classification.

In further aspects, the techniques described herein relate to a smart personal grooming device, wherein the hair length threshold includes: (a) a value of approximately 3.5 millimeters (mm); (b) a value selected between 0.3 mm and 3.5 mm; (c) a value selected between 0.3 millimeters (mm) and 1.5 mm; or (d) a value selected between 0.9 millimeters (mm) and 2.5 mm.

In some aspects, the techniques described herein relate to a smart personal grooming device, wherein the at least one classification includes one or more of: (a) a region to cut classification; (b) a region to stop classification; or (c) an edge region classification.

In some aspects, the techniques described herein relate to a smart personal grooming device, wherein the learning model is a neural network-based model.

In some aspects, the techniques described herein relate to a smart personal grooming device, wherein the at least one classification is based on one or more features identifiable with the one or more images, the one or more features including: hair color, hair length, skin color, skin tone, or skin texture.

In some aspects, the techniques described herein relate to a smart personal grooming device, wherein the plurality of images for training the learning model include images having height of 10 to 1944 pixels and width of 10 to 2592 pixels.

In some aspects, the techniques described herein relate to a smart personal grooming device, wherein the plurality of images for training the learning model include images having height of 32 pixels and a width of 32 pixels.

In some aspects, the techniques described herein relate to a smart personal grooming device, wherein the plurality of images for training the learning model include images having at least a width within 10 percent of a width of the hair cutting implement.

In some aspects, the techniques described herein relate to a smart personal grooming device further including: subdividing into a plurality of patches each of the one or more images depicting the skin area of the user and the hair area of the user as captured by the camera, and assigning a patch-based classification to each patch of the plurality of patches based on whether hair identified within a respective patch is depicted as above the hair length threshold or below the hair length threshold, wherein the control state is based on each patch-based classification.

In some aspects, the techniques described herein relate to a smart personal grooming device, wherein the computing instructions are further configured, when executed, to cause the processor to: subdivide into a plurality of patches each of the one or more images depicting the skin area of the user and the hair area of the user as captured by the camera, and assign a patch-based classification to each patch of the plurality of patches based on pixel analysis of each of the plurality of patches, wherein the control state is based on each patch-based classification.

In some aspects, the techniques described herein relate to a smart personal grooming device, wherein each patch includes an image region having a width of 160 pixels and a height of 32 pixels.

In some aspects, the techniques described herein relate to a smart personal grooming device including an infrared light source oriented toward the hair cutting implement and configured to illuminate the skin area and hair area of a user when operating the smart personal grooming device.

In some aspects, the techniques described herein relate to a smart personal grooming device further including a second infrared light source oriented toward the hair cutting implement and configured to illuminate the skin area and hair area of a user when operating the smart personal grooming device.

In some aspects, the techniques described herein relate to a smart personal grooming device, wherein the hair cutting implement includes a rotary shaver.

In some aspects, the techniques described herein relate to a smart personal grooming device, wherein the hair cutting implement includes a foil and an undercutter.

In some aspects, the techniques described herein relate to a smart personal grooming device, wherein the hair cutting implement includes a reciprocating blade.

In some aspects, the techniques described herein relate to a smart personal grooming method including: capturing, by a camera, one or more images depicting a skin area of a user and a hair area of the user, wherein the camera is positioned relative to a body including a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, detecting by a processor communicatively coupled to the camera, and based on one or more images, each of the skin area and the hair area, wherein a boundary is defined between the skin area and the hair area; determining, by the processor, a control state based on the boundary as detected in the one or more images; and implementing, by the processor based on the control state, at least one of: (a) activating the hair cutting implement to cause the hair cutting implement to remove hair in the hair area of the user; (b) deactivating the hair cutting implement; (c) activating of a haptic vibrator; (d) activating an audio device; (e) initiating a visual indicator; or (f) changing a cutting speed of the hair cutting implement.

In some aspects, the techniques described herein relate to a tangible, non-transitory computer-readable medium storing instructions for a smart personal grooming device, that when executed by a processor the smart personal grooming device, causes the processor to: capture, by a camera, one or more images depicting a skin area of a user and a hair area of the user, wherein the camera is positioned relative to a body including a handle, wherein a head portion is connected to the body and a hair cutting implement, and wherein the camera is oriented toward the hair cutting implement and configured to capture images of the skin area and the hair area of the user when the user uses the hair cutting implement to cut or trim hair, detect by the processor communicatively coupled to the camera, and based on one or more images, each of the skin area and the hair area, wherein a boundary is defined between the skin area and the hair area; determine, by the processor, a control state based on the boundary as detected in the one or more images; and implement, by the processor based on the control state, at least one of: (a) activate the hair cutting implement to cause the hair cutting implement to remove hair in the hair area of the user; (b) deactivate the hair cutting implement; (c) activate a haptic vibrator of the smart personal grooming device; (d) activate an audio device of the smart personal grooming device; (e) initiating a visual indicator of the smart personal grooming device; or (f) changing a cutting speed of the hair cutting implement.

In some aspects, the techniques described herein relate to a cutting method including: capturing, by a camera, one or more images depicting a first body area of a user and a second body area of the user, wherein the camera is positioned relative to a cutting device including a handle and a cutting implement, and wherein the camera is oriented toward the cutting implement and configured to capture images of the first body area and the second body area of the user, detecting by a processor communicatively coupled to the camera, and based on one or more images, each of the first body area and the second body area, wherein a boundary is defined between the first body area and the second body area; subdividing into a plurality of patches each of the one or more images depicting the first body area of the user and the second body area of the user as captured by the camera; assigning a patch-based classification to each patch of the plurality of patches based on pixel analysis of each of the plurality of patches; determining, by the processor, a control state based on the boundary as detected in the one or more images, wherein the control state is based on each patch-based classification; and implementing, by the processor based on the control state, at least one of: (a) activating the cutting implement to cause the cutting implement to remove hair in a hair area of the user; (b) deactivating the cutting implement; (c) activating of a haptic vibrator device; (d) activating an audio device; (e) initiating a visual indicator; or (f) changing a cutting speed of the cutting implement.

In some aspects, the techniques described herein relate to a cutting method, wherein a learning model stored in a memory communicatively coupled to the processor and trained with a plurality of images of user skin areas implements the detecting the first body area and the second body area defining the boundary, wherein the learning model is configured to output at least one classification based on whether a pixel-based element identified in an image of the plurality of images is depicted as above a threshold or below the threshold, and, wherein the control state is based on the at least one classification.

In addition, the present disclosure includes applying certain of the claim elements with, or by use of, a particular machine, e.g., a smart personal grooming device having a blade. The smart personal grooming device comprises a camera coupled to the shaving device configured to capture images of a skin area and a hair area of a user when operating the smart personal grooming device.

In addition, present disclosure includes improvements in computer functionality or in improvements to other technologies at least because the claims recite that, e.g., use of a camera as attached a smart personal grooming device configured to improve and enhance control or operation of the smart personal grooming device based on image input and analysis. That is, the present disclosure describes improvements in the functioning of the computer itself or “any other technology or technical field” because the control of the smart personal grooming device becomes more precise in its operation, e.g., to activate a hair cutting implement (e.g., a blade) to cause the hair cutting implement to remove hair in a hair area of the user. This improves over the prior art at least because conventional razors or otherwise cutting instruments lack such cutting precision or otherwise control.

In addition, the present disclosure includes specific features other than what is well-understood, routine, conventional activity in the field, or adds unconventional steps that confine the claim to a particular useful application, e.g., devices and methods for smart personal grooming as described herein.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example of a smart personal grooming device in accordance with various embodiments disclosed herein.

FIG. 2A illustrates an example front view of the smart personal grooming device of FIG. 1 as positioned with respect to a skin area and a hair area of a user in accordance with various embodiments disclosed herein.

FIG. 2B illustrates an example side view of the smart personal grooming device of FIG. 1 as positioned with respect to a skin area and a hair area of a user in accordance with various embodiments disclosed herein.

FIG. 3 illustrates a flowchart or algorithm of an example smart personal grooming method in accordance with various embodiments disclosed herein.

FIG. 4A illustrates example images of respective hair areas of a user in accordance with various embodiments disclosed herein.

FIG. 4B illustrates example images of respective skin areas of a user in accordance with various embodiments disclosed herein.

FIG. 5A illustrates an image depicting a boundary defined between a skin area and a hair area of a user, and a plurality of patches and related patch-based classifications of the image in accordance with various embodiments disclosed herein.

FIG. 5B illustrates a sequence of images depicting respective boundaries defined between a skin area and a hair area of a user, wherein each image pertains to a plurality of patches and related patch-based classifications in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

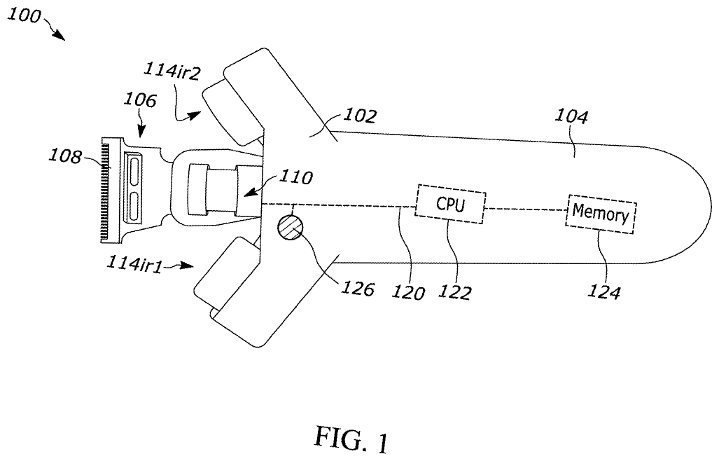

FIG. 1 illustrates an example of a smart personal grooming device 100 (e.g., an example AutoEdger device) in accordance with various embodiments disclosed herein. In the example of FIG. 1, smart personal grooming device 100 comprises a body 102 that includes a handle 104. The smart personal grooming device 100 further comprises a head portion 106 connected to body 102 and a hair cutting implement 108. In various implementations, the hair cutting implement may comprise a rotary shaver, a foil with an undercutter and/or a reciprocating blade. More generally, hair cutting implement 108 may comprise a trimmer, a cutter, or otherwise a blade-based device for cutting hair. In some implementations, haircutting implement 108 may be coupled to a motor (e.g., electric motor) for driving or otherwise actuating the haircutting implement 108, e.g., actuating a trimmer. In some implementations, the hair cutting implement can be removably connected. In various aspects, the hair cutting implement 108 may be detachable, and may comprise a cartridge or other detachable component, for coupling, decoupling, and/or otherwise attaching to head portion 106.

With further reference to FIG. 1, smart personal grooming device 100 further comprise a camera 110 oriented toward the hair cutting implement 108. In some implementations, smart personal grooming device 100 may optionally include one or more infrared light source(s). In the example implementation of FIG. 1, smart personal grooming device 100 includes an infrared light source 114ir1 and a second infrared light source 114ir2, each oriented toward the hair cutting implement 108.

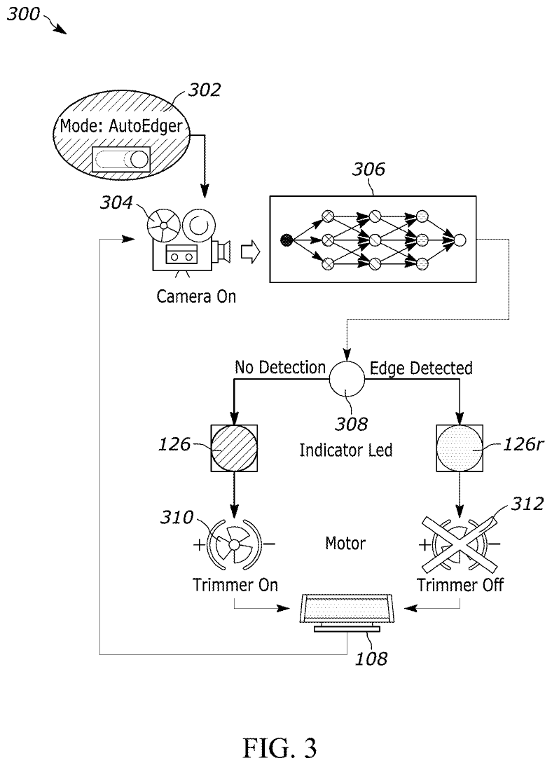

Smart personal grooming device 100 further comprises a processor 122 (e.g., a central processing unit (CPU)) communicatively coupled to the camera 110, through a computing bus 120, which may comprise an electrical or electronic circuit or connection. In some implementations, images or otherwise data, as captured by camera 110, may be provided to a separate or otherwise remote computing device, such as a mobile device or a remote server. Such images or data may be transmitted, for example, by a wireless or wired connection from a transceiver of the smart personal grooming device 100 to a wireless (e.g., WIFI or BLUETOOTH) access point, which may be a receiver of a mobile device (e.g., a mobile device implementing a mobile operating system, such as iOS or ANDROID) and/or a WIFI router connected to a computer network (e.g., the Internet). Where the images or data are received by a mobile device, a processor of the mobile device, may implement instruction stored thereon to analyze the images or data as described herein for processor 122 in view of the algorithm or method implemented by processor 122 (e.g., as described for FIG. 3). For example, a memory of the mobile device could store a learning model for analyzing and the images and data. Once analyzed, the output (e.g., output of the learning model) could be transmitted to the smart personal grooming device 100, via smart personal grooming device 100's transceiver, in order for operation of smart personal grooming device 100 according to the algorithms or methods as described herein, for example, as described herein for FIG. 3. Where the images or data are received by a server (e.g., via a WIFI router to a computer network, such as the Internet), a processor of the server may analyze the images or data as described herein for processor 122 in view of the algorithm or method implemented by processor 122 (e.g., as described for FIG. 3). For example, a memory of the server could store a learning model for analyzing and the images and data. Once analyzed, the output (e.g., output of the learning model) could be transmitted to the smart personal grooming device 100, via a computer network (e.g., the Internet) to the WIFI router and to the smart personal grooming device 100's transceiver, in order for operation of smart personal grooming device 100 according to the algorithms or methods as described herein, for example, as described herein for FIG. 3.

In some implementations, first infrared light source 114ir1 and/or second infrared light source 114ir2 may be communicatively coupled to processor 122 via computing bus 120. The infrared light source(s) (e.g., infrared light source 114ir1 and/or second infrared light source 114ir2) may be mounted next to, around, or in a proximity to camera 110 for uniform illumination in the region of interest on the surface observed (e.g., skin area 132 and/or hair area 134) by camera 110. In various aspects, a given light source may be switched on when the smart personal grooming device 100 is switched on or otherwise provided power. By utilizing camera 110 with the infrared light source(s) (e.g., infrared light source 114ir1 and/or second infrared light source 114ir2), camera 110 can capture image(s) in ambient lighting conditions with wavelengths sufficient for detecting regions of interest (e.g., skin area 132 and/or hair area 134). In some aspects, such wavelengths may correspond to visible spectrum between 400 nm and 700 nm. In some aspects, camera 110 may be configured to have no infrared filter, and thus may have an increased sensitivity to infrared spectrum, being able to detect wavelengths of light of less 800 nm. Still further, in some aspects, to enable the capture of clear images in low lighting conditions (e.g., a dark environment), infrared light source(s) (e.g., infrared light source 114ir1 and/or second infrared light source 114ir2) may be configured to output a wavelength ranging between 800 nm and 980 nm, so that camera 110 can capture image(s) for the detection of regions of interest (e.g., skin area 132 and/or hair area 134) in low lighting conditions.

In some aspects, smart personal grooming device 100 further comprises a light emitting diode (LED) 126 for indicating detection of an edge or boundary for purposes of determining a control state, for example, as described herein. Smart personal grooming device 100 further comprises a memory 124 communicatively via the computing bus 120 coupled to the processor and storing computing instructions that, when executed by the processor 122, causes the processor 122 to implement one or more algorithms or methods, e.g., for example including those as described herein. The computing instructions may comprise instructions compiled from or otherwise interpreted from one or more programming languages including, by way of non-limiting example, Java, C, C++, C#, Python, or the like. The computing instructions, when executed by processor 122, implement algorithms or otherwise methods, which may include, for example, capturing images with camera 110 and/or controlling the cutting implement of the smart personal grooming device 100 or otherwise modifying, updating, or changing a control state or other feature (e.g., vibration) of the smart personal grooming device 100, for example, as described herein with respect to FIG. 3 or otherwise herein.

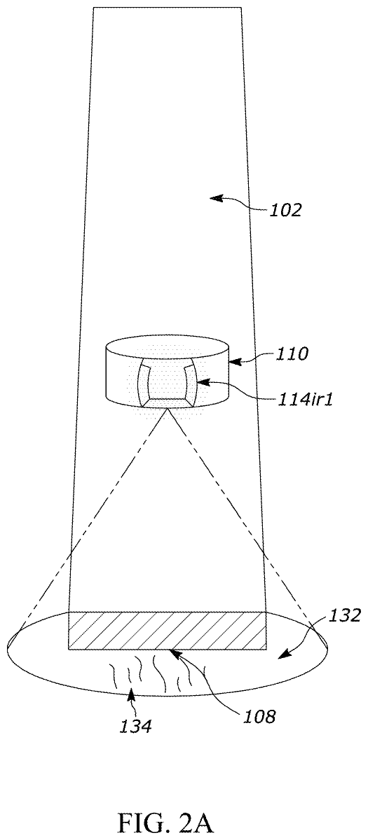

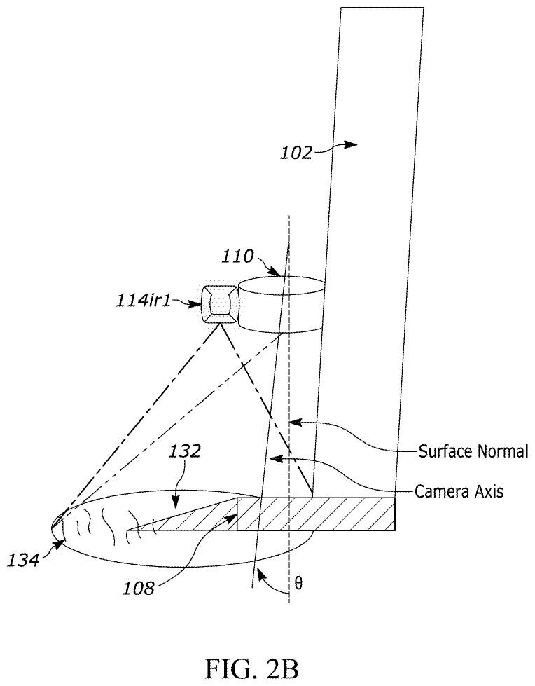

FIG. 2A illustrates an example front view of the smart personal grooming device 100 of FIG. 1 as positioned with respect to a skin area 132 and a hair area 134 of a user in accordance with various embodiments disclosed herein. In particular, as shown for FIG. 2A, camera 110 is attached to body 102 of smart personal grooming device 100. In various implementation, camera 110 may be switched on, or otherwise powered by a power source (e.g., battery, wired power source, or otherwise electrical connection) when the device is switched on or activated.

In various implementations, camera 110 may comprise an optical sensor capable of imaging a given area (e.g., a skin or hair area) of a user. Camera 110 may have an image resolution to capture images of a certain pixel density of the skin area 132 and a hair area 134 of the user near, at, or otherwise proximal to the location of the hair cutting implement 108. In one non-limiting example, camera 110 may comprise a low-resolution camera for capturing images at least 32 pixels wide by 32 pixels high.

In addition, camera 110 may be positioned in a proximity to an infrared light source, e.g., infrared light source 114ir1. For example, camera 110 may be mounted in a position to capture images illuminated by an infrared light source, e.g., infrared light source 114ir1. The camera 110 may be mounted without any infrared filter. As a result, it can capture images in the near-infrared (IR) spectrum. As shown for FIG. 2A, infrared light source 114ir1 is oriented toward hair cutting implement 108 and is configured to illuminate skin area 132 and hair area 134 of a user when operating the smart personal grooming device 100. While not shown in FIG. 2A, a second infrared light source (e.g., infrared light source 114ir2) can also be oriented toward the hair cutting implement 108 and may also be configured to illuminate skin area 132 and hair area 134 of the user when operating the smart personal grooming device. Use of infrared light source(s) is one way to determine whether the device is touching the user's skin surface, skin area, or hair area. It should be understood, however, that additional or different configurations or components could be used to determine if the device is touching the skin surface, skin area, or hair area to be treated. By way of non-limiting example, this can include time-of-flight (ToF) sensor(s) to determine skin surface, skin area, or hair area by detecting ToF data as transmitted and received by camera 110. Additionally, or alternatively, this can include a capacitive touch sensor positioned on the end of the smart personal grooming device 100 that can detect the skin surface, skin area, or hair area through electrical capacitance. Still further, additionally, or alternatively, this can also include detecting, by processor 122, the movement of a wheel encoder positioned on the end of the smart personal grooming device 100 that can detect the skin surface, skin area, or hair area when actuated (rolled) on the surface.

More generally, camera 110 is configured to capture image(s) depicting the skin area 132 of the user and the hair area 134 of the user. Processor 122 may then detect, based on pixel data within the images, each of the skin area 132 and/or the hair area 134. A boundary may be defined between the skin area 132 and the hair area 134, where the boundary may comprise an edge between the skin and hair, e.g., a linear area with skin having stubble and an area with a higher hair forming a beard of the user. The boundary or otherwise edge can be, at least initially, created, for example, by a barber or user using a razor, trimmer, or other device with a cutting implement.

Each of the skin area 132 and the hair area 134 defining the boundary may be detected based on pixel data within the images captured by camera 110. Each of these images may comprise pixel data (e.g., RGB data) representing feature data corresponding to skin and/or hair, within the respective image. Generally, as described herein, pixel data comprises individual points or squares of data within an image, where each point or square represents a single pixel within an image. Each pixel may be a specific location within an image. In addition, each pixel may have a specific color (or lack thereof). Pixel color may be determined by a color format and related channel data associated with a given pixel. For example, a popular color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel's area within the image. In some implementations, the three RGB components may be represented as three 8-bit numbers for each pixel. Three 8-bit bytes (one byte for each of RGB) is used to generate 24-bit color. Each 8-bit RGB component can have 256 possible values, ranging from 0 to 255 (i.e., in the base 2 binary system, an 8-bit byte can contain one of 256 numeric values ranging from 0 to 255). This channel data (R, G, and B) can be assigned a value from 0 255 and be used to set the pixel's color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values. So (Red=220, Green=220, Blue=220) is a light gray (near white), and (Red=40, Green=40, Blue=40) is a dark gray (near black).

In this way, the composite of three RGB values creates the final color for a given pixel. With a 24-bit RGB color image using 3 bytes there can be 256 shades of red, and 256 shades of green, and 256 shades of blue. This provides 256×256×256, i.e., 16.7 million possible combinations or colors for 24-bit RGB color images. In this way, the pixel's RGB data value shows how much of each of Red, and Green, and Blue pixel is comprised of. The three colors and intensity levels are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges.

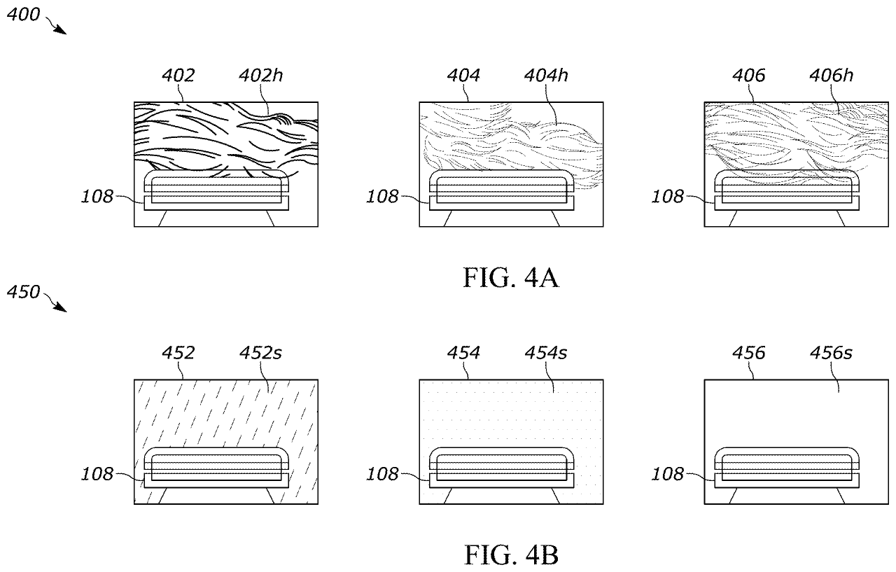

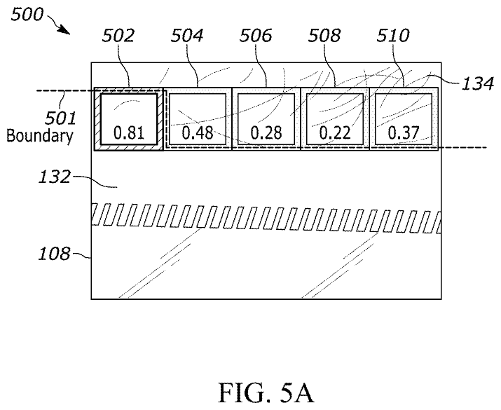

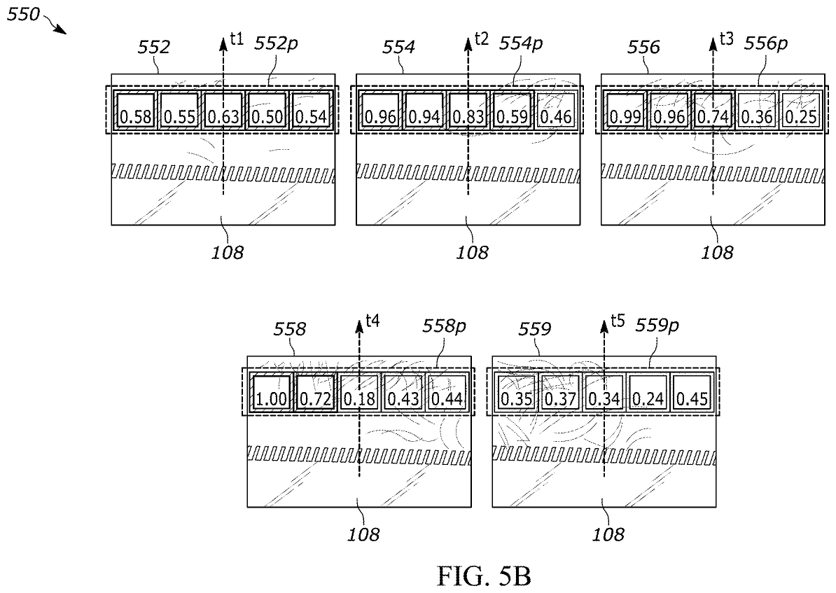

As a whole, the various pixels, positioned together in a grid pattern, form a digital image (e.g., any of the images as described herein, e.g., for FIGS. 4A, 4B, 5A, and/or 5B). A single digital image can comprise thousands or millions of pixels. Images can be captured, generated, stored, and/or transmitted in a number of formats, such as JPEG, TIFF, PNG and GIF. These formats use pixels to store represent the image.

In various aspects, processor 122 is configured to determine control state of the smart personal grooming device 100 based on the boundary as detected in the one or more images. For example, the control state may cause processor 122, when executing the computing instructions, to implement algorithms or otherwise methods, for example, as described herein with respect to FIG. 3 or otherwise herein. For example, in one aspect, such algorithm may comprise actuating a hair cutting implement 108 to cut the user's hair stubble.

FIG. 2B illustrates an example side view of the smart personal grooming device 100 of FIG. 1 as positioned with respect to skin area 132 and hair area 134 of a user in accordance with various embodiments disclosed herein. FIG. 2B shows the orientation of camera 110 and infrared light source 114ir1 with respect to body 102 and hair cutting implement 108. Generally, camera 110 is oriented toward hair cutting implement 108 and configured to capture images of skin area 132 and hair area 134 of the user when the user operates the smart personal grooming device 100. The camera 110 is configured to capture one or more images, e.g., a video or a series of frames or images, while the user operates the smart personal grooming device 100. Analysis of the images enables processor 122 to control or otherwise change operation or features of the smart personal grooming device 100 based on interpretation of the optical sensor feedback signal (e.g., analysis of the pixel data).

In some implementations, camera 110, or its lens, may be configured to have a constant focal length, or otherwise camera distance, relative to the skin area 132, hair area 134, and/or hair cutting implement 108. In a zoomed-in implementation, such focal length or otherwise camera distance may comprise a 2 millimeters (mm) to 5 mm distance from a lens of camera 110 to the skin area 132, hair area 134, and/or hair cutting implement 108. In another implementation, having a larger field of view for longer distances, such focal length or otherwise camera distance may comprise a 5 mm or greater distance from a lens of camera 110 to the skin area 132, hair area 134, and/or hair cutting implement 108.

Additionally, or alternatively, a camera orientation of camera 110 may be offset. For example, as shown for FIG. 2B, camera 110 may have an offset of +/−30 degrees relative to a surface angel of hair cutting implement 108. More generally, the angle between a camera axis of camera 110 and the surface normal can vary between 0 and 60 degrees. Offsetting, angling, or otherwise positioning the camera relative to skin area 132, hair area 134, and/or hair cutting implement 108 enables capturing of clear images for processing by processor 122. The capture of such clear images reduces noise in such images, which allows for precise and enhanced image analysis and thus control of the smart personal grooming device 100 due to less error prone image analysis.

FIG. 3 illustrates a flowchart or algorithm of an example smart personal grooming method 300 in accordance with various embodiments disclosed herein. In various implementations, smart personal grooming method 300 may comprise an algorithm, implemented by computing instructions, and executed by processor 122 of the smart personal grooming device 100, and stored in memory (e.g., memory 124). In some implementations, smart personal grooming method 300 may be implemented when a user has selected that an AutoEdger mode (block 302) be turned on or otherwise activated. Such selection or activation may be implemented via a switch, button, or display screen of the smart personal grooming device 100. In other implementations, smart personal grooming method 300 may be implemented when the smart personal grooming device 100 itself is powered on, e.g., in an always-on mode.

At block 304, smart personal grooming method 300 comprises capturing, by a camera (e.g. camera 110), one or more images depicting a skin area (e.g., skin area 132) of a user and a hair area (e.g., hair area 134) of the user, for example, as described herein for FIGS. 1, 2A, and 2B. The images may comprise one more frames of a video, e.g., where camera 110 comprises a video camera for capturing image(s) (e.g., frames) during operation of smart personal grooming device 100. The image(s) are captured while the user uses the hair cutting implement (e.g., hair cutting implement 108) to cut or trim hair as described herein.

At block 306, smart personal grooming method 300 comprises detecting by a processor (e.g., processor 122) communicatively coupled to the camera (e.g., camera 110), and based on one or more images, each of the skin area (e.g., skin area 132) and the hair area (e.g., hair area 134). In various aspects, the boundary may be an edge, line, or otherwise region be defined between the skin area and the hair area. More generally, a hairstyle may be defined by a predefined edge or boundary between the skin and hair, e.g., an edge of a beard or otherwise. For example, the boundary may be defined along a region where hair longer is longer than a given length. Smart personal grooming method 300 includes detecting the boundary, or otherwise predefined edge based on image analysis. This can include taking, as input from the camera 110, the one or more images and detecting the presence of hair longer than a threshold length. Such detection provides a region or area of the boundary or edge between the hair and the skin, e.g., an edge of a beard. The output of personal grooming method 300, or otherwise algorithm, is provided to instruct processor 122 to control smart personal grooming device 100, including, for example, to control the hair cutting implement 108. For example, such control may comprise outputting an electronic or digital command or signal to stop the trimmer when the predefined edge or otherwise boundary between the skin and hair (e.g., beard) is detected when the device moves from the skin to the hair and vice versa.

In some implementations, a learning model stored in the memory (e.g., memory 124) of smart personal grooming device 100. The learning model may be accessed by processor 122 implementing computing instructions to provide input and receive output from the learning model. The learning model may be trained with a plurality of images of users when operating the smart personal grooming device 100. For example, in some implementations, the plurality of images for training the learning model comprise images having height of 10 to 1944 pixels and width of 10 to 2592 pixels. In such implementations, a maximum resolution size of the camera (e.g., camera 110) may comprise a 2592 by 1944 resolution size. It should be understood, however, that different cameras having different resolution sizes may also be used, which could cause the image size and/or height, and related pixel density therefore, to be differently captured based on the cameras dimensioning and resolution sizing.

In various implements, the resolution may be changed, adjusted, or otherwise updated to focus on the areas of interest (e.g., skin area 132 and hair area 134) and/or otherwise enhance image quality for the purpose of training and/or using image(s), and therefore related pixel data, which improves the training and/or use of the underlying learning model. For example, in some implementations, a range of pixels (e.g., 25 pixels to 40 pixels) may be used. For example, such range may be based on width of a cutting implement (e.g., hair cutting implement 108). Additionally, or alternatively, the range may be based on distance of the camera to the user's skin. Additionally, or alternatively, the range may be based on camera resolution, where, for example, the camera has a resolution and/or is positioned at a certain distance from the user's skin such that a view or otherwise image of the user's skin where the blade contacts the user's skin comprises an area having a 25 to 40 pixel height and a 25 to 40 pixel width.

In various aspects, the height and width of the images can be fixed, where the image size and height used for training have the same image size and height as the images used for input into the model for detecting the boundary or otherwise edge. In one non-limiting example, the images for training the learning model, as well as for later using the trained model, comprise images having height of 32 pixels and a width of 32 pixels. In other implementations, the images for training the learning model, as well as for later using the trained model, comprise images having at least a width within 10 percent of a width of the hair cutting implement 108. It is to be understood, however, that other pixel heights and widths may be utilized herein. For example, pixel sizing or resolution of images captured by camera 110 may be configured to be larger or smaller depending on the size of an area of hair to be removed or size of the hair removal device itself (e.g., the smart personal grooming device 100).

In various implementations, and as indicated in FIG. 3, the learning model comprises a neural network-based model. In such implementations, the neural network-based model is trained on images as input, including the pixel data of the images that detail areas of interest (e.g., skin area 132 and hair area 134). In some aspects, the neural network is trained using a back propagation to adjust the weights of each node in the neural network to detect hair and/or skin for the purpose of detecting the boundary or edge as described herein. The neural network is trained to output a classification to determine a boundary or edge between skin and hair (e.g., a beard) and/or state of the trimmer head.

More generally, in various embodiments, the learning model (e.g., as stored in memory 124) is an artificial intelligence (AI) based model, such as a machine learning model, trained with at least one AI algorithm. Training of learning model involves image analysis of the training images to configure weights of learning model, and its underlying algorithm (e.g., machine learning or artificial intelligence algorithm) used to predict and/or classify future images. For example, in various embodiments herein, generation of learning model involves training learning model with the plurality of training images of a plurality of users, where each of the training images comprise pixel data of a skin areas and hair areas of respective users. In some embodiments, one or more processors of a server or a cloud-based computing platform may receive the plurality of training images of the plurality of users via a computer network (e.g., the Internet). In such embodiments, the server and/or the cloud-based computing platform may train the learning model with the pixel data of the plurality of training images. More generally, the images may be trained by a computing device sufficient to access a large number of images for training the learning model as described herein.

In various embodiments, a learning model, as described herein, may be trained using a supervised or unsupervised machine learning program or algorithm. The machine learning program or algorithm may employ a neural network, which may be a convolutional neural network, a deep learning neural network, or a combined learning model or program that learns in two or more features or feature datasets (e.g., pixel data) in a particular areas of interest. The machine learning model may also include support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms may be included as a library or package executed by a computing device, such as a server, for training the learning model as describe herein. For example, libraries may include the TENSORFLOW based library, the PYTORCH library, and/or the SCIKIT-LEARN Python library.

Machine learning may involve identifying and recognizing patterns in existing data (such as training a model based on pixel data within images having pixel data of a skin area and/or hair area of a respective individuals) in order to facilitate making prediction(s) or classification(s) for subsequent data (such as using the model on new pixel data of a new individual in order to determine one or more classifications, and related classification values, for a skin area or a hair of a user as described herein).

Machine learning model(s), such as the learning model described herein for some embodiments, may be created and trained based upon example data (e.g., “training data” and related pixel data) inputs or data (which may be termed “features” and “labels”) in order to make valid and reliable predictions or classifications for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict or classify, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction or classification accuracy when given test level or production level data or inputs, is generated. The disclosures herein may use one or both of such supervised or unsupervised machine learning techniques. In addition, in various aspects, the learning model may be updated, over time, with new images as new training data in order to improve the accuracy of the predictions and/or classifications as output by the learning model.

At block 308, smart personal grooming method 300 comprises determining, by the processor 122, a control state of the smart personal grooming device 100 based on the boundary as detected in the one or more images. In various aspects, the boundary may be determined by analysis of the pixel data. For example, in various implementations, the learning model (e.g., as stored in memory 124) is configured to output at least one classification based on whether hair identified in an image of the plurality of images is depicted as above a hair length threshold or below the hair length threshold, where the hair length threshold may comprise a value or setting stored in memory 124 of smart personal grooming device 100. For example, a hair threshold length can be based on measurable values of hair stubbles (i.e., newly growing hair in the skin area 132). More generally, the hair length threshold value may comprise a hair stubble value of less than 3500 (micrometer) um length. Additionally, or alternatively, a hair length threshold value may comprise a range of values. For example, the hair length threshold may comprise: (a) a value of approximately 3.5 millimeters (mm); (b) a value selected between 0.3 mm and 3.5 mm; (c) a value selected between 0.3 millimeters (mm) and 1.5 mm; and/or (d) a value selected between 0.9 millimeters (mm) and 2.5 mm. Still further, a range may be based on a predetermined time period of growth of hair. For example, in some implementations, a range could be between 0.3 mm and 3.5 mm for 1 to 7 days of growth. Additionally, or alternatively, a range could be between 0.3 mm to 1.5 mm for 1 to 3 days of growth. Additionally, or alternatively, a range could be between 0.9 mm to 2.5 mm for 3 to 5 days of growth.

With further reference to FIG. 3, at block 308, the control state of the smart personal grooming device 100 can be based on the at least one classification, e.g., as determined based on the boundary as detected in the one or more images. Example classifications (e.g., as output by the learning model) may comprise any one or more of a region to cut classification, a region to stop classification, and/or an edge region classification. For example, a region to cut classification (which could be identified or labeled as an “Region to Cut”) could be assigned to regions of an image where hair is detected having a value at or below the hair length threshold. Further, a region to stop classification (which could be identified or labeled as an “Region to Stop”) could be assigned to regions of an image where bare skin is detected or otherwise where hair is detected having a value at or above the hair length threshold. Regions identified in an image (e.g., in the pixel data of an image) having hair both above and below the hair length threshold could be identified as an edge region classification (which could be identified or labeled as an “Edge Region”). In this way, the images captured by camera 110 may be captured and input into the learning model to detect the predefined edge, or otherwise boundary, between the skin, stubble, and/or hair.

In various implementations, each of the one or more classifications may be based on one or more features identifiable with the one or more images and/or pixel data thereof. For example, the one or more features identifiable in the images or by the pixel data may comprise hair color, hair length, skin color, skin tone, or skin texture. The image classifications are learned from training a learning-based model (e.g., the learning model) on pixel data of images of one or more individuals comprising pixel data of skin areas and hair areas of a plurality of individuals. For example, the learning model may be trained with pixel data (e.g., including RGB values of pixel data) a plurality of training images of respective skin and hair areas of users. The weights of the model may be trained via analysis of various RGB values of individual pixels of a given image. For example, dark or low RGB values (e.g., a pixel with values R=25, G=28, B=31) may indicate presence of hair or stubble against the user's skin. Still further, pixel values having a pattern of different colored pixels dotted in the given area may indicate presence of hair or stubble against the user's skin. By contrast, pixel values having the same or similar value in a linear or stringed manner may represent longer hair or hair having a certain hair length threshold. Still further, pixel values indicating the absence of skin tones may further indicate a hair area (as opposed to a skin area) within a given image. Still further, a line or edge defined in image(s) by pixel data having different or contrasting colors (e.g., RGB values) may indicate the presentence of an edge or boundary of a given hairline (e.g., a beard). In this way, pixel data (e.g., detailing one or more features of an individual, such as user skin areas hair areas having different specific pixel RGB values(s) as identifiable within 10,000s training images may be used to train or use the learning imaging model to detect, based on one or more images, each of the skin area and the hair area, where, at least in some images, a boundary is defined between the skin area and the hair area. The control state of smart personal grooming device 100 can then be determined therefrom.

With further reference to FIG. 3, block 308 of smart personal grooming method 300 comprises implementing, by the processor based on the control state, at least one of several algorithms or methods. For example, if no boundary, edge, stubble, is detected (e.g., based on detected hair along a boundary being below a hair length threshold value based on the image or pixel analysis), then at block 310, smart personal grooming method 300 comprises activating the hair cutting implement (e.g., hair cutting implement 108) to cause the hair cutting implement to remove hair in the hair area of the user. This may include, by way of non-limiting example, turning a motor of smart personal grooming device 100 on in order to trim or cut hair. This may further include updating the LED 126 (e.g., chaining it to a green color) to indicate that the motor is on.

By contrast, at block 308, if a boundary, edge, stubble, is detected (e.g., based on detected hair along a boundary being above or at a hair length threshold value based on the image or pixel analysis), then at block 310, smart personal grooming method 300 comprises deactivating the hair cutting implement (e.g., hair cutting implement 108) to cause the hair cutting implement to stop. This may include, by way of non-limiting example, turning a motor of smart personal grooming device 100 off. This may further include updating the LED 126r (e.g., chaining it to a red color) to indicate that the motor is off.

Additionally, or alternatively, smart personal grooming method 300 may comprise implementing, by the processor 122 based on the control state, an algorithm comprising activating of a haptic vibrator of the smart personal grooming device 100, activating an audio device of the smart personal grooming device 100, and/or initiating a visual indicator (e.g., LED 126). of the smart personal grooming device. Any one or more of the haptic vibrator, audio device, visual indicator may indicate, for example, when the boundary is detected and/or when the motor of the smart personal grooming device 100 is turned on or off.

Additionally, or alternatively, smart personal grooming method 300 may comprise implementing, by the processor based on the control state, an algorithm comprising changing a cutting speed of the hair cutting implement. This may include, for example, changing a stroke speed during a shaving session of the user. For example, when the smart personal grooming device 100 is operating, the stroke speed of the motor of the smart personal grooming device 100 can be varied between a range of speeds such as 1 mm/s to 50 mm/s.

FIG. 4A illustrates example images 400 (e.g., images 402, 404, and 406) of respective hair areas (e.g., 402 h, 404h, and 406h) of a user in accordance with various embodiments disclosed herein. As shown for FIG. 4A, each of images 402, 404, and 406 depicts hair cutting implement 108 (e.g., a trimmer) engaged in trimming hair, or otherwise positioned next to hair, in respective hair areas 402h, 404h, and 406h. Each of the images 402, 404, and 406 comprise pixel data, which may be analyzed for detecting or otherwise identifying hair areas (e.g., 402h, 404h, and 406h) as described for smart personal grooming method 300, or otherwise the algorithm thereof, for FIG. 3 or elsewhere herein. Further, the pixel data of images 402, 404, and 406 may be used for training the learning model as described herein, including for training the learning model to classify the images 402, 404, and 406 as a region to stop (not cut), where each of the images include pixel data indicative a hair area (e.g., hair area 134) of a user.

FIG. 4B illustrates example images 450 (e.g., images 452, 454, and 456) of respective skin areas (e.g., skin areas 452s, 454s, and 456s) of a user in accordance with various embodiments disclosed herein. As shown for FIG. 4B, each of images 452, 454, and 456 depicts hair cutting implement 108 (e.g., a trimmer) next to the user's skin in respective skin areas 452s, 454s, and 456s. Each of the images 452, 454, and 456 comprise pixel data, which may be analyzed for detecting or otherwise identifying skin areas (e.g., 452h, 454h, and 456h) as described for smart personal grooming method 300, or otherwise the algorithm thereof, for FIG. 3 or elsewhere herein. Further, the pixel data of images 452, 454, and 456 may be used for training the learning model as described herein, including for training the learning model to classify the images 452, 454, and 456 as region to cut, where each of the images include pixel data indicative a skin area (e.g., skin area 132) of a user, and where the skin area may include hair stubble to trim or cut.

FIG. 5A illustrates an image 500 depicting a boundary 501 defined between a skin area 132 and a hair area 134 of a user. FIG. 5A further depicts a plurality of patches (e.g., patches 502, 504, 506, 508, and 510) and related patch-based classifications (e.g., patch-based classifications having values of 0.81, 0.48, 0.28, 0.22, and 0.37, respectively) of image 500 in accordance with various embodiments disclosed herein. As shown for FIG. 5A, hair cutting implement 108 is positioned on the user's skin area 132. Opposite of the hair cutting implement 108, image 500 depicts the user's hair area 134. Image 500 also depicts several patches (e.g., patches 502, 504, 506, 508, and 510) each having an assigned or otherwise detected classification and related classification value. The patches may each comprise a certain pixel height and width (e.g., 32 pixels by 32 pixels) within image 500. In some implementations, each patch may comprise a length and/or width corresponding to (such as equal to, or slightly larger than) a length and/or width the hair cutting implement (e.g., a trimmer blade) or portion thereof, as shown for FIG. 5A. For example, in some implementations, each patch may comprise an image region having a width of 160 pixels and a height of 32 pixels (e.g., which could cover an area or portion of hair cutting implement 108). Still further, in some implementations, the patches may be superimposed on an image (e.g., image 500). In other implementations, the patches may not be superimposed, but instead determined by processor 122.

With further reference to FIG. 5A, patch 502 comprises a pixel area that has an assigned or detected classification, e.g., a region to cut classification (Region to Cut). The classification may be based on patch 502's related classification value of 0.81, which may indicate a probability (e.g., an 81% chance) that pixels detected within patch 502 of image 500 have been detected as below a given hair classification value. That is, the patch-based classification value of 0.81 indicates that patch 502 has hair, as detected within the pixels of patch 502, as being below a given hair length threshold as set for the smart personal grooming device 100, e.g., to control smart personal grooming device 100 to cut or trim hair stubble of the user.

Similarly, each of patches 504, 506, 508, and 510 comprises a pixel area that has an assigned or detected classification, e.g., a region to stop classification (Region to Stop). The classification may be based on each of the patch's related classification values (e.g., 0.48, 0.28, 0.22, and 0.37, respectively), which may indicate respective probabilities (e.g., 48% chance, 28% chance, 22% chance, and 37% chance, respectively) that pixels detected within the related patches (504, 506, 508, and 510, respectively) of image 500 have been detected as below a given hair classification value. That is, the patch-based classification values (e.g., 0.48, 0.28, 0.22, and 0.37, respectively) indicates that the related patches (504, 506, 508, and 510, respectively) has hair, as detected within the respective pixels, as being below a given hair length threshold value as set for the smart personal grooming device 100. Because the probabilities are low, then each of the patch-based classifications for patches 504, 506, 508, and 510 are determined as a region to stop classification (Region to Stop), e.g., to control smart personal grooming device 100 to not cut the longer hair (e.g., a bear) of the user.

While the probabilities in the above example suggest that higher probabilities (e.g., above 50%) indicate a region to cut classification, and that lower probabilities (e.g., below 50%) indicate a region to stop classification, it should be understood that different probabilities may be used. For example, the probability thresholds for determination or detection of region to stop or region to cut could be changed to any value on a percentage scale, where, for example, a higher percentage (or lower percentage as the case may be) may cause one classification or the other to be assigned or detected more frequently (or not). Still further, the probabilities may be reversed, where a higher probably (e.g., above 50%) suggests that a region to cut classification is assigned or detected, and vice versa with respect to a lower probability.

With further reference to FIG. 5A, a plurality of patches (e.g., patches 502, 504, 506, 508, and 510) may define a boundary, e.g., boundary 501. The boundary may be classified or detected as an edge between skin area 132 and hair area 134. The detection of the boundary may cause the edge of a given patch, or otherwise portion of a given patch, to be assigned or detected as an edge region classification (an Edge Region). The edge region classification (i.e., Edge Region) may define an edge of a beard or other hairstyle, such as a line or shaping of a user's hair.

In various implementations, processor 122 may determine, detect, or create patches with respect to a given image as capture by camera 110. For example, computing instructions (e.g., as stored on memory 124 of smart personal grooming device 100) are configured, when executed, to cause the processor 122 to subdivide into a plurality of patches (e.g., patches 502, 504, 506, 508, and 510) an image (e.g., image 500) depicting the skin area (e.g., skin area 132) of the user and the hair area (e.g., hair area 134) of the user as captured by the camera (e.g., camera 110). Processor 122 may then assign a patch-based classification (e.g., a region to cut classification, a region to stop classification, or an edge classification) to each patch of the plurality of patches based on pixel analysis of each of the plurality of patches. The control state of smart personal grooming device 100 may then be determined, by processor 122, based on each patch-based classification.

In various implementations, the learning model (as described herein) outputs the patch-based classification(s) to determine the control state of the smart personal grooming device 100. In some implementations, pixel data of one or more images (e.g., image 500) may be used for training learning model or for inputting into an already trained learning model to implement the algorithm or otherwise method of FIG. 3 or elsewhere as described herein. For example, image 500 comprises example pixel data of skin area 132 (depicting skin and stubble features), hair area 134 (e.g., having long hair features), and hair cutting implement 108 (e.g., comprising mechanical or metallic features) that may be used for training and/or implementing a learning model (e.g., learning model), in accordance with various embodiments disclosed herein. For example, hair area 134, which includes patches 504, 506, 508, and 510, comprises long hair that depicts darker pixels (e.g., pixels with low R, G, and B values) or pixels shaped in linear, curly, consecutive, string-like, or hair-shaped pattern. Skin area 132 may depict spotty or randomized patches of different colored pixels, when compared to the broader color region of the user skin, thereby representative of hair stubble on the user's skin. Still further, hair cutting implement 108 may comprise brighter pixel colors (e.g., a pixels with high R, G, and B values) indicating metal or mechanical features of hair cutting implement 108. Such pixel data may be used to determine the boundary within image 500 and/or make classification for the various patches image 500 for controlling smart personal grooming device 100.

Additionally, or alternatively, an algorithm to determine a control of the smart personal grooming device 100 may be implemented with computing instructions (e.g., non-AI computing instructions), that may comprise if-then-else logic based on, e.g., physical parameters of hair edges, hair color, skin color, length of hair, shape of hair (e.g., curliness of hair) as identified by one or more pixel(s) of the patches. That is, a procedural (non-AI) method (if-then-else) would focus on pixel intensity of RGB values of the individual pixels as detected when the smart personal grooming device 100 moves from skin-to-hair areas or vice versa of a user. In such implementations, an image (e.g., image 500) may be subdivided into a plurality of patches (e.g., patches 502-510, where each of the one or more images depict the skin area (e.g., skin area 132) of the user and the hair area (e.g., hair area 134) of the user as captured by the camera (e.g., camera 110). Processor 112 is configured to assign a patch-based classification to each patch of the plurality of patches based on whether hair identified within a respective patch is depicted as above the hair length threshold or below the hair length threshold. The control state may then be determined or otherwise based on each patch-based classification.

FIG. 5B illustrates a sequence 550 of images (e.g., 552, 554, 556, 558, and 559) depicting respective boundaries defined between a skin area and a hair area of a user, wherein each image pertains to a plurality of patches (e.g., 552p, 554p, 556p, 558p, and 559p) and related patch-based classifications (e.g., classifications regarding cutting, stopping, or edge detected) in accordance with various embodiments disclosed herein. Sequence 550 may represent a series of images (e.g., a video of image frames) as captured by camera 110. The series of images may be analyzed or otherwise processed as described herein, for example, by smart personal grooming method 300 as described herein for FIG. 3. The sequence 550 of image depicts hair cutting implement 108 of smart personal grooming device 100 (the AutoEdger) moving from a skin area (e.g., skin area 132) of the user towards a hair area (e.g., hair area 134) of the user at different points of time t₁ to t₅. That is, image 552 shows hair cutting implement 108 at t₁, image 554 shows hair cutting implement 108 at t₂, image 556 shows hair cutting implement 108 at t₃, image 558 shows hair cutting implement 108 at t₄, and image 559 shows hair cutting implement 108 at t₅. When a boundary is detected (e.g., in image 554), the patch-based classification changes from a region to cut classification (e.g., as shown for image 554 with patches 552p having above 50% values with respect to the hair length threshold value) to a region to stop classification (e.g., as shown for image 554 with one patch below a 50% value with respect to the hair length threshold value). Later-in-time images (images 556, 558, and 559) have further patches classified, based on pixel analysis, as regions to stop classifications. Each of the remaining images (images 556, 558, and 559) have an increasing number of patches having classification values of less than 50% with respect to the hair length threshold value, thus indicating an increased number of patches with a region to stop classification as hair cutting implement 108 moves toward the hair area (e.g., a beard) of the user across time (e.g., t₂ to t₅). Thus, when a patch is classified as a region to stop classification, processor 122 signals the motor of smart personal grooming device 100 to stop, which prevents the cutting or trimming action of hair cutting implement 108.

In a more detailed example, and with reference to FIG. 5B, a learning model (such as a neutral network) is deployed on smart personal grooming device 100, for example, by storing the learning model in memory 124. The model may be deployed and/or stored to smart personal grooming device 100 and trained with images showing skin areas and hair areas, as described and depicted herein. In one implementation, the computing instructions, as executed by processor 122, cause camera 110 of smart personal grooming device 100 to capture images (e.g., video), such as the image shown in sequence 550. In some implementations, the images may be cropped or reduced in size. For example, the images may be cropped to a width of 160 pixels and a height of 32 pixels.

In some implementations, the cropped image may be further subdivided into patches (e.g., patches 502, 504, 506, 508, and 510; or patches as shown in plurality of patches or otherwise patch groups 552p, 554p, 556p, 558p, and 559p), where each patch has with a width of 32 pixels and a height of 32 pixels. As described herein, however, other pixel heights and widths may be used.

In the example implementation, the learning model classifies each patch as one of a region to cut classification, a region to stop classification, and an edge region classification. When the user moves the smart personal grooming device 100 (and thus hair cutting implement 108) from the skin area towards the hair area, if at least one patch is detected as a region to stop classification at the predefined edge (e.g., boundary) between the hair (e.g., a beard) and skin, then processor 122 signals the motor of smart personal grooming device 100 to stop, and the trimmer actuator and/or the trimmer blade stops its cutting or trimming action. Otherwise, processor 122 signals the motor to operate, and the actuator and/or the trimmer blade performs a cutting or trimming action to remove hair stubble. The classifications (e.g., region to cut classification, region to stop classification, and an edge region classification) are each based on a hair length threshold value, which may be a setting stored in memory 124. For example, based on a probability output by the learning model, the computing instructions executing on processor 122 determines the probability of a given patch being classified as a region to cut based on the hair length threshold value. If this probability value is greater than a set threshold (e.g., above 50%), then the processor 122 signals the motor to operate, causing the trimmer blade to cut or trim stubble. Otherwise, the processor 122 signals the motor to stop, and no cutting or trimming action occurs.

### Additional Considerations

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A smart personal grooming device comprising:
a body comprising a handle;
a head portion connected to the body and a hair cutting implement;
a camera oriented toward the hair cutting implement and configured to capture images of a skin area and a hair area of a user when operating the smart personal grooming device;
a processor communicatively coupled to the camera; and
a memory communicatively coupled to the processor and storing computing instructions that, when executed by the processor, causes the processor to:
capture, by the camera, one or more images depicting the skin area of the user and the hair area of the user,
detect, based on one or more images, each of the skin area and the hair area, wherein a boundary is defined between the skin area and the hair area; and
determine a control state based on the boundary as detected in the one or more images,
wherein the control state causes the computing instructions to execute the processor to implement at least one of:
(a) activate the hair cutting implement to cause the hair cutting implement to remove hair in the hair area of the user;
(b) deactivate the hair cutting implement;
(c) activate of a haptic vibrator of the smart personal grooming device;
(d) activate an audio device of the smart personal grooming device;
(e) initiate a visual indicator of the smart personal grooming device; or
(f) changing a cutting speed of the hair cutting implement.

2. The smart personal grooming device of claim 1 further comprising:
a learning model stored in the memory and trained with a plurality of images of users when operating the smart personal grooming device,
wherein the learning model is configured to output at least one classification based on whether hair identified in an image of the plurality of images is depicted as above a hair length threshold or below the hair length threshold, and
wherein the control state is based on the at least one classification.

3. The smart personal grooming device of claim 2, wherein the hair length threshold comprises: (a) a value of approximately 3.5 millimeters (mm); (b) a value selected between 0.3 mm and 3.5 mm; (c) a value selected between 0.3 millimeters (mm) and 1.5 mm; or (d) a value selected between 0.9 millimeters (mm) and 2.5 mm.

4. The smart personal grooming device of claim 2, wherein the at least one classification comprises one or more of: (a) a region to cut classification; (b) a region to stop classification; or (c) an edge region classification.

5. The smart personal grooming device of claim 2, wherein the learning model is a neural network-based model.

6. The smart personal grooming device of claim 2, wherein the at least one classification is based on one or more features identifiable with the one or more images, the one or more features comprising: hair color, hair length, skin color, skin tone, or skin texture.

7. The smart personal grooming device of claim 2, wherein the plurality of images for training the learning model comprise images having height of 10 to 1944 pixels and width of 10 to 2592 pixels.

8. The smart personal grooming device of claim 7, wherein the plurality of images for training the learning model comprise images having height of 32 pixels and a width of 32 pixels.

9. The smart personal grooming device of claim 2, wherein the plurality of images for training the learning model comprise images having at least a width within 10 percent of a width of the hair cutting implement.

10. The smart personal grooming device of claim 2 further comprising:
subdividing into a plurality of patches each of the one or more images depicting the skin area of the user and the hair area of the user as captured by the camera, and
assigning a patch-based classification to each patch of the plurality of patches based on whether hair identified within a respective patch is depicted as above the hair length threshold or below the hair length threshold,
wherein the control state is based on each patch-based classification.

11. The smart personal grooming device of claim 1, wherein the computing instructions are further configured, when executed, to cause the processor to:
subdivide into a plurality of patches each of the one or more images depicting the skin area of the user and the hair area of the user as captured by the camera, and
assign a patch-based classification to each patch of the plurality of patches based on pixel analysis of each of the plurality of patches,
wherein the control state is based on each patch-based classification.

12. The smart personal grooming device of claim 9, wherein each patch comprises an image region having a width of 160 pixels and a height of 32 pixels.

13. The smart personal grooming device of claim 1 comprising an infrared light source oriented toward the hair cutting implement and configured to illuminate the skin area and hair area of a user when operating the smart personal grooming device.

14. The smart personal grooming device of claim 11 further comprising a second infrared light source oriented toward the hair cutting implement and configured to illuminate the skin area and hair area of a user when operating the smart personal grooming device.

15. The smart personal grooming device of claim 1, wherein the hair cutting implement comprises a rotary shaver.

16. The smart personal grooming device of claim 1, wherein the hair cutting implement comprises a foil and an undercutter.

17. The smart personal grooming device of claim 1, wherein the hair cutting implement comprises a reciprocating blade.

18. A smart personal grooming method comprising:
capturing, by a camera, one or more images depicting a skin area of a user and a hair area of the user, wherein the camera is positioned relative to a body comprising a handle, wherein a head portion is connected to the body and a hair cutting implement, and wherein the camera is oriented toward the hair cutting implement and configured to capture images of the skin area and the hair area of the user when the user uses the hair cutting implement to cut or trim hair,
detecting by a processor communicatively coupled to the camera, and based on one or more images, each of the skin area and the hair area, wherein a boundary is defined between the skin area and the hair area;
determining, by the processor, a control state based on the boundary as detected in the one or more images; and
implementing, by the processor based on the control state, at least one of:
(a) activating the hair cutting implement to cause the hair cutting implement to remove hair in the hair area of the user;
(b) deactivating the hair cutting implement;
(c) activating of a haptic vibrator;
(d) activating an audio device;
(e) initiating a visual indicator; or
(f) changing a cutting speed of the hair cutting implement.

19. The smart personal grooming method of claim 18 further comprising:
outputting, by a learning model, at least one classification based on whether hair identified in an image of a plurality of images is depicted as above a hair length threshold or below the hair length threshold,
wherein the learning model is stored in a memory and trained with the plurality of images of users when operating the smart personal grooming device, and
wherein the control state is based on the at least one classification.

20. A tangible, non-transitory computer-readable medium storing instructions for a smart personal grooming device, that when executed by a processor the smart personal grooming device, causes the processor to:
capture, by a camera, one or more images depicting a skin area of a user and a hair area of the user, wherein the camera is positioned relative to a body comprising a handle, wherein a head portion is connected to the body and a hair cutting implement, and wherein the camera is oriented toward the hair cutting implement and configured to capture images of the skin area and the hair area of the user when the user uses the hair cutting implement to cut or trim hair,
detect by the processor communicatively coupled to the camera, and based on one or more images, each of the skin area and the hair area, wherein a boundary is defined between the skin area and the hair area;
determine, by the processor, a control state based on the boundary as detected in the one or more images; and
implement, by the processor based on the control state, at least one of:
(a) activate the hair cutting implement to cause the hair cutting implement to remove hair in the hair area of the user;
(b) deactivate the hair cutting implement;
(c) activate a haptic vibrator of the smart personal grooming device;
(d) activate an audio device of the smart personal grooming device;
(e) initiating a visual indicator of the smart personal grooming device; or
(f) changing a cutting speed of the hair cutting implement.
